(19) United States
(12) Patent Application Publication
(10) Pub. No.: US 2026/0197621 A1
(43) Pub. Date: Jul. 9, 2026

(54) USER-CENTRIC RELAYING SERVICES

(71) Applicant: InterDigital Patent Holdings, Inc., Wilmington, DE (US)

(72) Inventors: Chonggang Wang, Princeton, NJ (US); Xu Li, Plainsboro, NJ (US); Robert Gazda, Spring City, PA (US)

(73) Assignee: InterDigital Patent Holdings, Inc., Wilmington, DE (US)

(21) Appl. No.: 19/132,261

(22) PCT Filed: Nov. 22, 2023
(86) PCT No.: PCT/US2023/080944

§ 371 Date: May 22, 2025

Related U.S. Application Data
(60) Provisional application No. 63/427,236, filed on Nov. 22, 2022.

(51) Int. Cl. H04W 8/00; H04W 12/69

(52) U.S. Cl. CPC H04W 8/005; H04W 12/69

(57) ABSTRACT

Systems, methods, and instrumentalities are disclosed for user-centric relaying services. In examples, a relay wireless transmit/receive unit (WTRU) may receive, from a remote WTRU, a discovery solicitation. The discovery solicitation may include one or more of a remote WTRU User-Centric Identifier (UCi), a remote WTRU User-Centric Credential (UCC) type, or a preferred relay WTRU UCC type. The relay WTRU may verify the remote WTRU UCI based on the discovery solicitation. The relay WTRU may authenticate the discovery solicitation using the verified WTRU UCI. The relay WTRU may send a discovery response to the remote WTRU based on the discovery solicitation being authenticated. The discovery response may include one or more of a relay WTRU UCI, a preferred remote WTRU UCC type, or a relay WTRU UCC. The relay WTRU may receive, from the remote WTRU, a discovery report. The discovery report may be based on a confirmation received from the remote WTRU. The WTRU may send the discovery report to a network node.

### CROSS-REFERENCE TO RELATED APPLICATIONS

This application claims the benefit of Provisional U.S. Patent Application No. 63/427,236, filed Nov. 22, 2022, the disclosure of which is incorporated herein by reference in its entirety.

### BACKGROUND

Mobile communications using wireless communication continues to evolve. A fifth generation of mobile communication radio access technology (RAT) may be referred to as 5G new radio (NR). A previous (legacy) generation of mobile communication RAT may be, for example, fourth generation (4G) long-term evolution (LTE).

### SUMMARY

Systems, methods, and instrumentalities are disclosed for user-centric relaying services. In examples, a relay wireless transmit/receive unit (WTRU) may receive, from a remote WTRU, a discovery solicitation. The discovery solicitation may include at least one of a remote WTRU User-Centric Identifier (UCI), a remote WTRU User-Centric Credential (UCC) type, or a relay WTRU UCC type. The relay WTRU may verify the remote WTRU UCI based on the discovery solicitation. The relay WTRU may authenticate the discovery solicitation using the verified remote WTRU UCI. The relay WTRU may send a discovery response to the remote WTRU if the discovery solicitation is authenticated. The discovery response may include at least one of a relay WTRU UCI, a preferred remote WTRU UCC type, or a relay WTRU UCC. The relay WTRU may receive a discovery report from the remote WTRU. The discovery report may be based on a confirmation received from the remote WTRU. The relay WTRU may send the discovery report to a network node.

The network node may include a distributed ledger system (DLS). The relay WTRU may send a discovery announcement to the remote WTRU. The discovery announcement may include at least one of the relay WTRU UCI, the relay WTRU UCC type, or a relay-effective time. The relay-effective time may indicate a duration of time that the relay WTRU provides a relaying service. The relay WTRU may verify the remote WTRU UCC type based on the discovery solicitation.

The confirmation may include at least one of a first confirmation indication indicating that the relay WTRU UCI and the relay WTRU UCC type are valid, or a second indication indicating that the remote WTRU may request relaying service from the relay WTRU. The discovery report may include at least one of the remote WTRU UCI, the relay WTRU UCI, a timestamp indicating when the discovery report was generated, a verification status of the remote WTRU UCC type, or a verification status of the relay WTRU UCC type. The relay WTRU may verify the discovery report. The discovery report may be verified based on a signature of the remote WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example system architecture.

FIG. 3 illustrates examples wherein a WTRU may be used as a relay.

FIGS. 4A/B depict a technique for generating user-centric identifiers (UCI) and user-centric credentials (UCC) for remote WTRUs and relaying WTRUs.

FIG. 5 illustrates a user-centric device discovery technique that may provide trustworthy direct device discovery between remote WTRUs and relaying WTRUs.

FIG. 6 illustrates a user-centric relaying service request technique.

### DETAILED DESCRIPTION

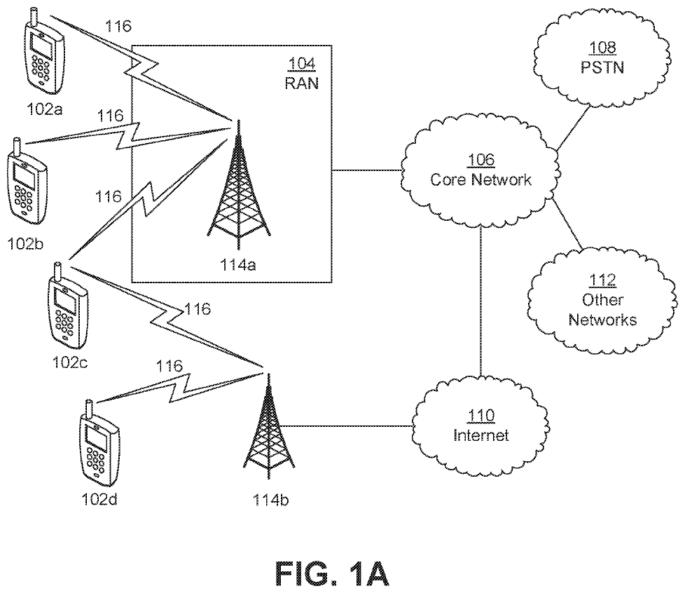

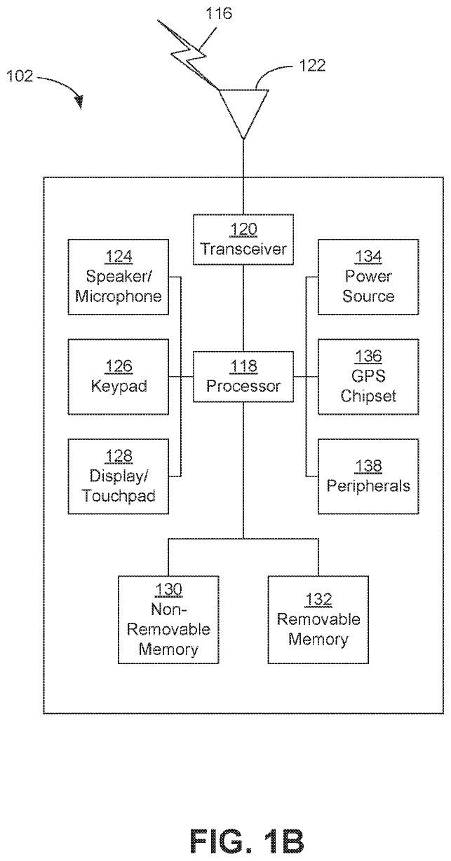

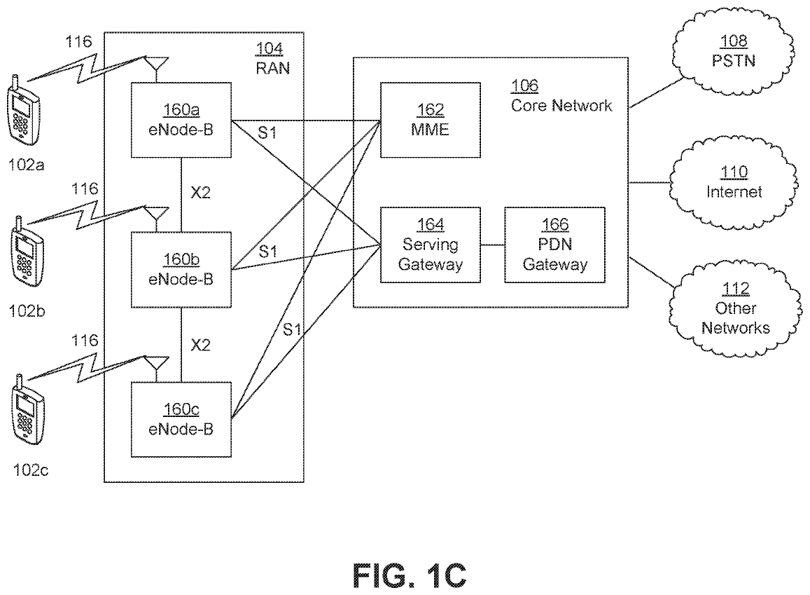

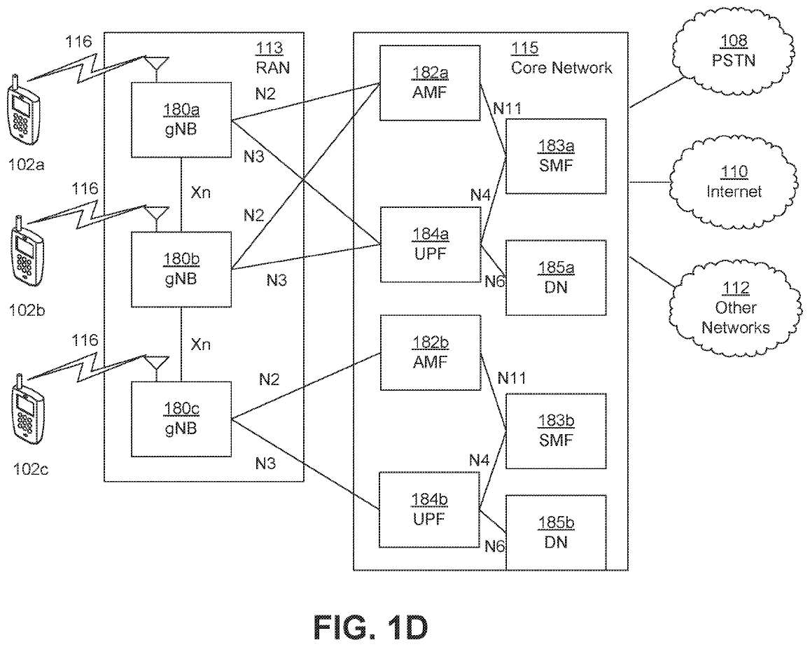

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or another device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to the determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a timer expiration herein may refer to determining that the time has occurred or that the period of time has expired.

Table 1 depicts abbreviations that may be used herein.

TABLE 1

| | |
|---|---|
| 3GPP | 3rd Generation Partnership Project |
| 5G | 5th Generation |
| 5GC | 5G Core Network |
| 5GS | 5G System |
| AF | Application Function |
| AUSF | Authentication Server Function |
| DLS | Distributed Ledger System |
| ID | Identifier |
| NF | Network Function |
| NRF | Network Repository Function |
| NW | Network |
| PCF | Policy Control Function |
| ProSe | Proximity based Service |
| SA | Service Architecture |
| UCC | User-Centric Credential |
| UCCI | User-Centric Credential Issuer |
| UCI | User-Centric Identifier |
| UDM | Unified Data Management |
| UDR | Unified Data Repository |
| UDSF | Unstructured Data Storage Function |
| UE | User Equipment |

Systems, methods, and instrumentalities are disclosed for user-centric relaying services. In examples, a relay wireless transmit/receive unit (WTRU) may receive, from a proximity service (ProSe) function, a first message, and the first message may include a request to configure the relay WTRU with a type of user-centric identifier (UCI) and a type of user-centric credential (UCC). The relay WTRU may send a second message to the ProSe function in response to the first message. The second message may include the type of UCI corresponding with the relay WTRU and the type of UCC corresponding with the relay WTRU. The relay WTRU may generate a UCI in accordance with the first message. The relay WTRU may send, to a user-centric credential issuer (UCCI), a third message, and the third message may include a request to generate a UCC based at least on the UCI and the type of UCC. The relay WTRU may receive, from the UCCI, a fourth message. The fourth message may include a request to present an existing UCC of the relay WTRU to the UCCI. The relay WTRU may based on the fourth message, send the existing UCC to the UCCI. The relay WTRU may receive the UCC from the UCCI. The relay WTRU may configure the relay WTRU with the UCI and the UCC.

Embodiments described herein may provide one or more of the following techniques: User-Centric Identifier (UCI) Generation, User-Centric Credential (UCC) Generation, UCI-Aware Device Discovery, and/or UCC-Aware Relaying Service Request.

A Proximity based Service (ProSe) may include WTRU-to-NW and WTRU-to-WTRU relaying functions and techniques. Examples may include establishing a trust relationship between (e.g., two) communication devices when they are from different organizations and have no previous trust relationships. For example, there may not be a previous relationship between a WTRU-to-NW relay (e.g., a relaying WTRU) and remote WTRUs, and between a WTRU-to-WTRU relay (e.g., a relaying/relay WTRU) and remote WTRUs. In such examples, the remote WTRU and relaying WTRU may be from different organizations, and there may not be a pre-established trust relationship between the remote WTRU and the relaying WTRU.

Examples may include generating User-Centric Identifiers (UCI) and User-Centric Credentials (UCC) (e.g., that ProSe may request). Examples may include enabling trustworthy ProSe direct discovery. Examples may include enabling trustworthy ProSe service request and direct communication.

A ProSe may use a relaying WTRU to connect a remote WTRU to the network or another remote WTRU. The trust between relaying WTRUs and remote WTRUs may be relevant when they are from different organizations and do not have pre-established trust relationships. In examples, user-centric trustworthy relaying services may be described herein.

Examples may include User-Centric Identifier (UCI) and/or User-Centric Credential (UCC) Generation. A ProSe function may designate the types of UCI and UCC for remote WTRUs and relaying WTRUs. Remote WTRUs and relaying WTRUs may generate their own UCI (e.g., a remote WTRU UCI and/or a relay WTRU UCI) meeting the requested (e.g., required) type from the ProSe function. Remote WTRUs and relaying WTRUs may interact with UCC issuers to request their UCC matching the requested (e.g., required) types from the ProSe function.

Embodiments described herein may include UCI-Aware device discovery. A remote WTRU and a relaying WTRU may discover one other, including their UCIs. The remote WTRU and the relay WTRU may validate and verify their UCI during the discovery technique. If a relaying WTRU cannot verify the remote WTRU's UCI, or if the remote WTRU UCI is invalid, the relaying WTRU may not disclose itself to the remote WTRU. The remote WTRU may not accept the relaying WTRU if the UCI of the relaying WTRU is invalid and/or cannot be verified.

Examples may include a UCC-Aware Relaying service request. A remote WTRU may request relaying service from a relaying WTRU by presenting its UCC (e.g., the remote WTRU UCC) and user-centric service specifications. The relaying WTRU may verify the remote WTRU's UCC and authenticate the remote WTRU. The relaying WTRU may share its UCC (e.g., the relaying WTRU UCC) with the remote WTRU so that the remote WTRU may verify the relaying WTRU's UCC. The relaying WTRU and remote WTRU may build a trusting relationship and start direct communication.

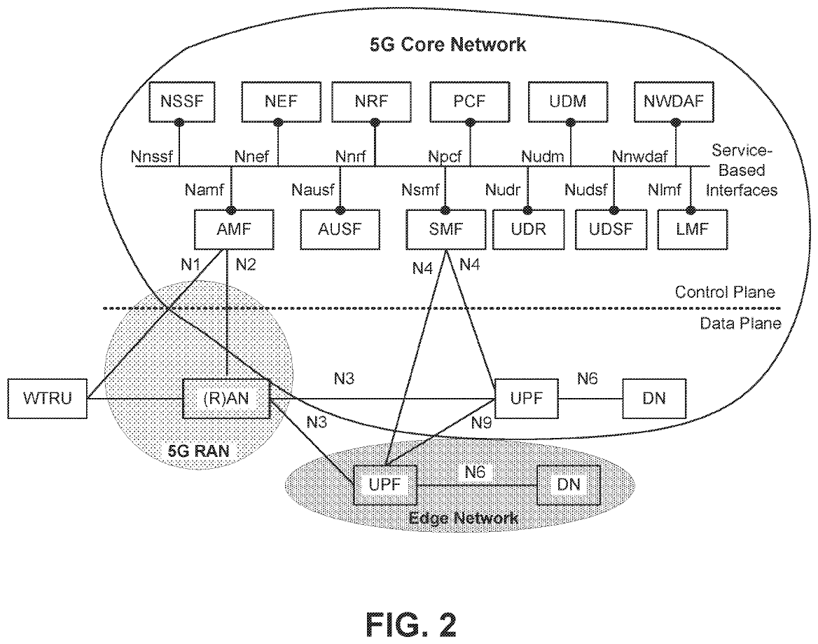

FIG. 2 illustrates an example system architecture. The example system architecture may include a WTRU, Radio Access Network (RAN), and Core Network (CN). In examples, the system architecture may be service-centric or service-based. As shown in FIG. 2, a CN may include network functions that may work (e.g., work together) to fulfill and provide services to a RAN, a WTRU, and an application server/service provider. A network function may access another network function, for example, in a request/response mode or subscription/notification mode. Network functions (e.g., two network functions) may interact with one another. The (e.g., two) network functions may (e.g., first) register with a Network Repository Function (NRF) so that the (e.g., two) network functions may discover one other via the NRF. An Access and Mobility Management Function (AMF) among the network functions may be dedicated to managing a WTRU's access to a system and its mobility. A Session Management Function (SMF) may establish sessions between a WTRU and a core network.

An Authentication Server Function (AUSF) may take charge of WTRU authentication. A Policy Control Function (PCF) may provide policy rules for (e.g., other) control plane network functions and WTRUs. The PCF may assign an identifier for a created policy rule, which (e.g., other) control plane network functions and WTRUs may use to refer to the corresponding policy rule. A User Plane Function (UPF) may be a function for the user plane to facilitate monitoring, managing, controlling, and redirecting user plane traffic flows, for example, between a WTRU and an Application Server (AS). A Network Exposure Function (NEF) may enable access to control plane functions to entities, such as network applications and application servers (AS), which may be outside the system and not in the same trusted domain. The core network may provide data storage and analytics services through functions like Unified Data Management (UDM), Unified Data Repository (UDR), Unstructured Data Storage Function (UDSF), and Network Data Analytics Function (NWDAF).

Examples may include network slicing, which may be facilitated by a Network Slice Selection Function (NSSF). Although the network functions may be defined as separate logical entities, an example may include multiple network functions. For example, WTRU mobility may include an AMF, an AUSF, and an SMF. For a type of network function, instances (e.g., multiple instances) may be instantiated, and an NRF may maintain the information of an instantiated network function instance. Network functions of a Core Network such as a UPF and/or a NEF may be deployed and reside in an edge network near and/or co-located with the RAN.

Features described herein may include an architecture for Proximity based Services (ProSe). For example, a WTRU may be used as a relay (e.g., WTRU-to-NW relay) and may connect (e.g., other) remote WTRUs in proximity to the network. For example, a remote WTRU may leverage the WTRU-to-NW relay (e.g., another WTRU) to access the base station and core network. ProSe functions may include ProSe direct discovery, direct communication, and/or ProSe WTRU-to-Network Relay.

ProSe direct discovery may describe a technique for nearby WTRUs (e.g., remote WTRUs and WTRU-to-NW relays) to use direct radio transmissions to discover one other. ProSe direct communication may refer to a technique where multiple WTRUs in proximity communicate with one other (e.g., directly) without going through a network node (e.g., the base station). A ProSe WTRU-to-NW relay may provide functions to support connecting one or more remote WTRUs to the network via a WTRU-to-Network relay.

Architecture examples may be described herein, for example, WTRU-to-WTRU relay for unicast, modifications of ProSe WTRU-to-Network functionality, and/or path switching between direct New Radio (NR) Un communication path and direct NR PC5 communication path. For example, a WTRU-to-WTRU relay may include a ProSe-enabled WTRU that provides functions to and connects a remote/end WTRU to another remote/end WTRU.

Examples may include one or more of the following: supporting a WTRU-to-WTRU relay; supporting path switching between (e.g., two) indirect network communication paths for WTRU-to-Network relaying with service continuity consideration; supporting direct communication path switching between PC5 and Uu; supporting path switching between a direct network communication path and an indirect network communication path for (e.g., layer-2) WTRU-to-Network relay with session continuity consideration; supporting multi-path transmission for WTRU-to-Network relay; supporting PC5 service authorization and policy/parameter provisioning; or, supporting an emergency for WTRU-to-Network relaying.

Examples include relaying services in systems. In examples, the systems may include converged computing and communications. For example, computing and networking resources may be deeply integrated and jointly managed to serve users and devices. A WTRU may provide communication-oriented relaying services (e.g., ProSe) and relaying services that may rely on or leverage the computing and storage resources at a relaying WTRU.

Wireless systems may be open and distributed. For example, computing/storage resources may be distributed (e.g., everywhere) in the system. For example, computing/storage resources may be provided and/or shared by different entities (e.g., WTRUs and networking nodes). The entities may be from different organizations and may not have pre-established trust relationships. Relaying services may include the convergence of computing and communication and trustworthy relaying for entities from different organizations and administrative domains.

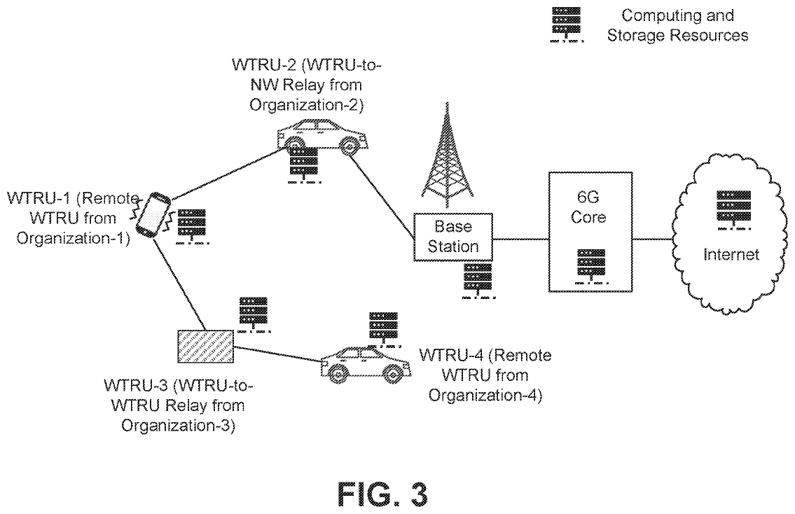

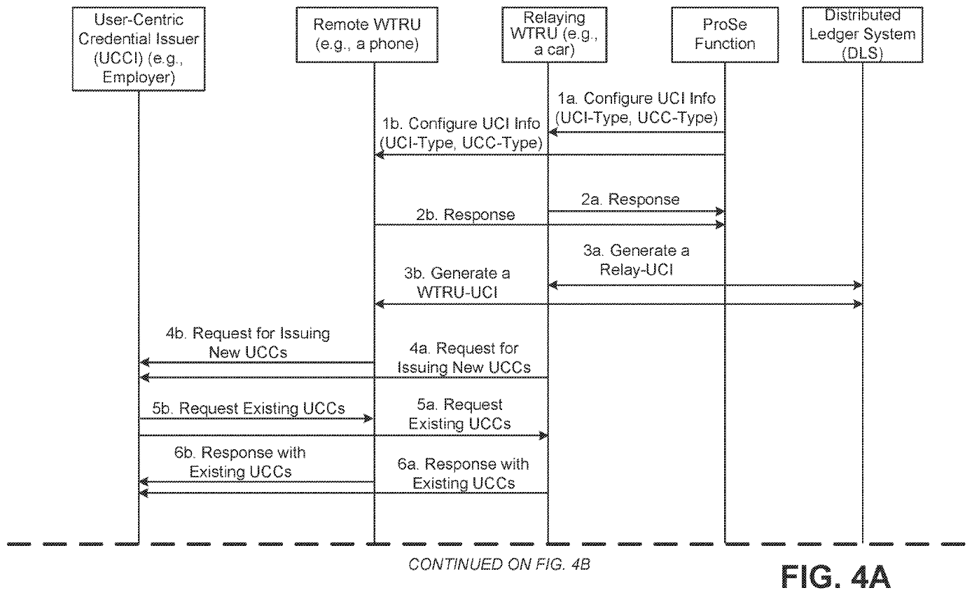

FIG. 3 illustrates (e.g., two) WTRU-as-a-Relay examples. In FIG. 3, four WTRUs may come from (e.g., be associated with) organizations (e.g., different organizations) and may not have pre-established trust, and WTRU-1 may use relaying compute/communications services provided by WTRU-2. WTRU-1 and WTRU-4 may use relaying compute/communications services from WTRU-3.

In examples involving WTRU-to-NW-Relaying, WTRU-2 may be a WTRU-to-NW relay, which provides relaying services (e.g., communications, computing, and storage) for WTRU-1 to connect WTRU-1 to the network (e.g., base station). WTRU-1 may connect to WTRU-2 (e.g., via a direct link), and WTRU-2 may connect to the base station via a direct link. WTRU-1 may request communication relaying from WTRU-2, and WTRU-1 may request computing/storage from WTRU-2.

In an example (e.g., involving WTRU-to-WTRU relaying), WTRU-3 may be a WTRU-to-WTRU relay, which may provide relaying services (e.g., communications, computing, and storage) for WTRU-1 and WTRU-4 (e.g., by connecting them directly). For example, there may be (e.g., two) direct links: a direct link between WTRU-1 and WTRU-3; and a direct link between WTRU-3 and WTRU-4. WTRU-1 and WTRU-4 may request communication relaying from WTRU-3, and WTRU-1 and WTRU-4 may request computing/storage from WTRU-3.

WTRU-to-NW and WTRU-to-WTRU relaying functions and techniques may be described herein. Examples may be associated with establishing trust between two communication devices when they are from different organizations and have no previous relationships. Examples may be associated with establishing a trust relationship between a WTRU-to-NW relay and remote WTRUs. Examples may be associated with establishing a trust relationship between a WTRU-to-WTRU relay and remote WTRUs to provide relay compute/communications services across administrative domains. In examples, a user-centric identifier and user-centric credential may be generated, which may be used in or requested by relaying services in wireless systems. Examples may include trustworthy direct device discovery between the relaying WTRU and other WTRUs. Examples may include enabling trustworthy direct communication between the relaying WTRU and other WTRUs.

A ProSe may use a relaying WTRU to connect a remote WTRU to the network or another remote WTRU. The trust between relaying WTRUs and remote WTRUs may be relevant when the WTRUs are from different organizations and do not have a pre-established trust relationship. Examples of user-centric trustworthy relaying services are described herein.

Examples may include User-Centric Identifier (UCI) and User-Centric Credential (UCC) Generation. For example, a ProSe function may designate types of UCI and UCC for remote WTRUs and relaying WTRUs. Remote WTRUs and relaying WTRUs may generate their own UCI meeting the requested (e.g., required) type from a ProSe function. Remote WTRUs and relaying WTRUs may interact with UCC issuers to request their UCC matching the types requested (e.g., required) from a ProSe function.

An example may include UCI-Aware Device Discovery. For example, a remote WTRU and a relaying WTRU may discover one another, including their respective UCIs. For example, the WTRUs (e.g., the relaying WTRU and the remote WTRU) may validate and verify their respective UCI during the discovery technique. If a relaying WTRU cannot verify the remote WTRU's UCI, or if the remote WTRU's UCI is invalid, the relaying WTRU may not disclose itself to the remote WTRU. The remote WTRU may not accept the relaying WTRU if the UCI of the relaying WTRU is invalid and/or cannot be verified.

Examples may include the UCC-Aware Relaying Service Request. A remote WTRU may request relaying service from a relaying WTRU by presenting its UCC and (e.g., other) user-centric service specifications. For example, the relaying WTRU may verify the remote WTRU's UCC and authenticate the remote WTRU. The relaying WTRU may share its UCC with the remote WTRU, and the remote WTRU may verify the relaying WTRU's UCC. The WTRUs (e.g., the remote WTRU and the relay WTRU) may build a trust relationship and may start direct communications.

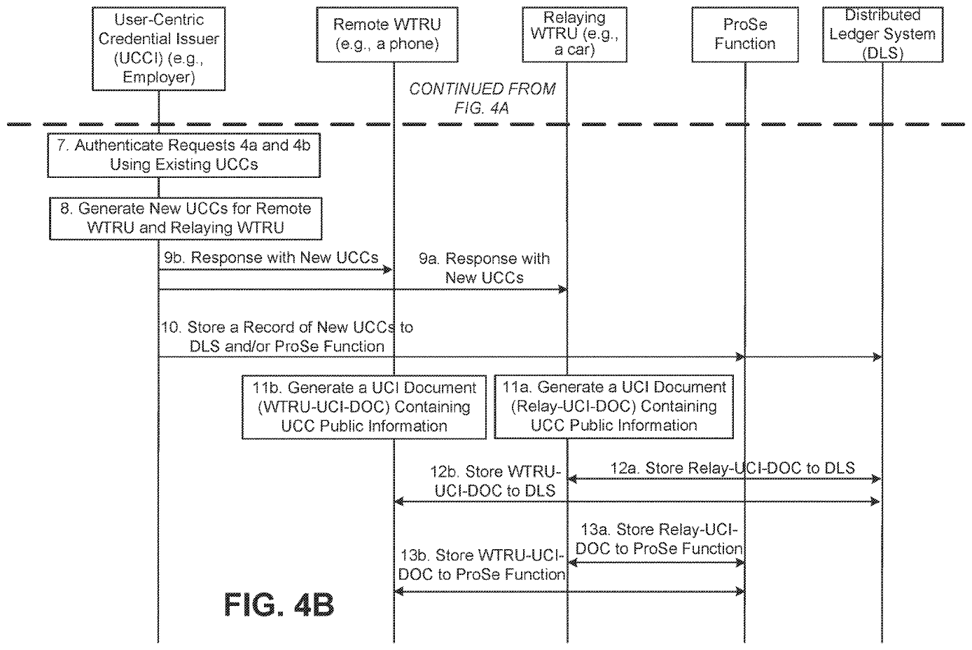

FIGS. 4A/B illustrate a technique for generating UCIs and user-centric credentials UCCs for remote WTRUs and relaying WTRUs. For example, a ProSe technique may configure types of UCI and UCC for remote WTRUs and relaying WTRUs. Remote WTRUs and relaying WTRUs may independently interact with a Distributed Ledger System (DLS) to generate and register their UCI. For generating UCC(s), remote WTRUs and relaying WTRUs may independently interact with a User-Centric Credential Issuer (UCCI) which may issue the requested UCC to remote WTRUs and relaying WTRUs.

An entity (e.g., a remote WTRU and a relaying WTRU) may generate its own UCI in different formats/types. The entity may own the generated UCI. In examples, a UCI may include a Self-Sovereign Identity (SSI) and Decentralized Identifier (DID). A generated UCI may include associated public information and parameters, which may be included in a UCI document (UCI-DOC). The UCI-DOC may be stored in the DLS for entities/parties to access. The UCI-DOC may be (e.g., uniquely) identified and found using the corresponding UCI. The parameters included in a UCI-DOC (e.g., UCI-DOC-A), for example, UCI-A, may include one or more of the following: a description of the UCI-A; UCI-Type may indicate a type of the UCI-A, the technique used to generate the UCI-A, and/or the format of the UCI-A; a public key of the entity that the UCI-A represents or a public key of the entity that owns the UCI-A; Group-UCI may indicate the identifier of a group that the UCI-A belongs to; Member-UCI may indicate a list of UCIs for other members of the group represented by Group-UCI; Child-UCI may indicate a list of UCIs that the UCI-A may have as child UCIs; Patent-UCI may indicate a list of UCIs that the UCI-A belongs to as a child UCI; Generation-Time may indicate the time the UCI-A may be generated; or, Expiration-Time may indicate the time the UCI-A becomes invalid.

For a UCC received from a UCCI, remote WTRUs or relaying WTRUs may maintain the UCC locally. A UCC-B generated by an example UCCI-B for an example entity B (e.g., a remote WTRU or a relaying WTRU) may include one or more of the following parameters: Holder-UCI may indicate the UCI of the entity B that the UCC-B was generated for; UCC-Type may indicate the type of UCC-B (e.g., the type/category of statements about the entity B); Statement-for-Holder may indicate one or more statements about the entity B. For example, a statement may be “the entity B has graduated from a University-B with a bachelor's degree;” Issuer-UCI may indicate the UCI of UCCI-B that generated the UCC-B; Issuer-Signature may indicate the UCCI-B's signature for the UCC-B; or, Issuer-Public-Key may indicate the UCCI-B's public key.

The method shown in FIGS. 4A/B may include one or more actions. At 1a/1b, a ProSe function may send a request to configure a relaying WTRU (e.g., 1a) and a remote WTRU (e.g., 1b) with (e.g., required) types for UCI and UCC. The request may include the following parameters: a UCI-Type that indicates the type of UCI that the remote WTRU or the relaying WTRU has and/or a UCC-Type that indicates the type of UCC that the remote WTRU or the relaying WTRU has or requests from the UCCI.

In examples, the relay WTRU (e.g., and/or the remote WTRU) may (e.g., actively) send a request to a ProSe function to check a UCI-Type and/or a UCC-Type for (e.g., as required by) the ProSe function. The ProSe function may send a response including the (e.g., required) UCI-Type and UCC-Type to the relay WTRU (e.g., and/or the remote WTRU).

At 2a/2b (e.g., as an acknowledgment to 1), the relaying WTRU (e.g., 2a) and the remote WTRU (e.g., 2b) may send a response to the ProSe function. The remote WTRU and the relaying WTRU may report the types of their existing UCI and UCC (e.g., the remote WTRU UCI and UCC and the relaying WTRU UCI and UCC) to the ProSe function through the response.

At 3a/3b, the relaying WTRU and/or the remote WTRU may generate a UCI according to UCI-Type. If UCI-Type indicates a DLS (e.g., a blockchain system), the relaying WTRU and/or the remote WTRU may contact the DLS to register the UCI to the DLS (e.g., sending a transaction to itself).

At 4a/4b, the relaying WTRU and the remote WTRU (e.g., either singly or in combination) may send a request to a UCCI for generating a UCC (e.g., a new UCC) by indicating the UCI of the relaying WTRU and/or the remote WTRU. According to a UCC-Type received (e.g., at 1a/1b), the relaying WTRU (e.g., and the remote WTRU) may determine an appropriate UCCI that may generate a UCC as designed by the UCC-Type. For example, the request may include the same UCC-Type received at 1a/1b. In examples, the relaying WTRU and the remote WTRU may request a (e.g., new) UCC from (e.g., different) UCCI(s).

At 5a/5b, before issuing a UCC (e.g., a new UCC) to the relaying WTRU and the remote WTRU, the UCCI may authenticate the relaying WTRU and the remote WTRU. The UCCI may request the relaying WTRU and the remote WTRU to present an existing UCC to the UCCI. In examples, the remote WTRU may not obtain the first UCC. The request may include a UCC-Type indicating the type of UCC that the UCCI is requesting.

At 6a/6b, the relaying WTRU (e.g., and the remote WTRU) may send an existing UCC matching the UCC-Type at 5a (e.g., and at 5b) to the UCCI.

At 7, the UCCI may verify the received UCC at 6a (e.g., and at 6b) to authenticate the relaying WTRU's request at 4a (e.g., and the remote WTRU's request at 4b). In examples, another UCCI-C may have issued the received UCC. To verify the received UCC, the UCCI may retrieve the UCI-DOC of UCCI-C from the DLS to get the UCCI-C's public information (e.g., the public key). The UCCI may use the UCCI-C's public information to verify the UCCI-C's signature and/or another field included in the received UCC. If the received UCC is invalid, the UCCI may stop and not perform one or more additional actions.

At 8, the UCCI may generate a new UCC for the relaying WTRU and/or a new UCC for the remote WTRU as requested (e.g., by the relaying WTRU and/or the remote WTRU) at 4a/4b.

At 9a/9b, the UCCI may send the UCCs (e.g., the new UCCs) to the relaying WTRU and the remote WTRU, respectively.

At 10, the UCCI may create a UCC Record A for the generated UCC for the relaying WTRU and a UCC Record B for the generated UCC for the remote WTRU. The UCC Record A may include one or more of the following: the type of the generated UCC for the relaying WTRU, the relaying WTRU's UCI, the time the UCC for the relaying WTRU was generated, or the UCCI's UCI.

The UCC Record B may include one or more of the following information: the type of the generated UCC for the remote WTRU, the remote WTRU's UCI, the time when the UCC for the remote WTRU was generated, or the UCCI's UCI.

The UCCI may store the UCC Record A and the UCC Record B to the ProSe function and/or DLS (e.g., by sending a UCCI-UCI and the content of both UCC Records to the ProSe function and/or DLS).

At 11a/11b, the relaying WTRU (e.g., and the remote WTRU) may generate a UCI document including public information in the received UCC at 9a (e.g., and at 9b), for example, as a UCI-Type and an Issuer-UCI.

At 12a/12b, the relaying WTRU and/or the remote WTRU may store the UCI document in the DLS.

At 13a/13b, the relaying WTRU and/or the remote WTRU may store the UCI document in the ProSe function.

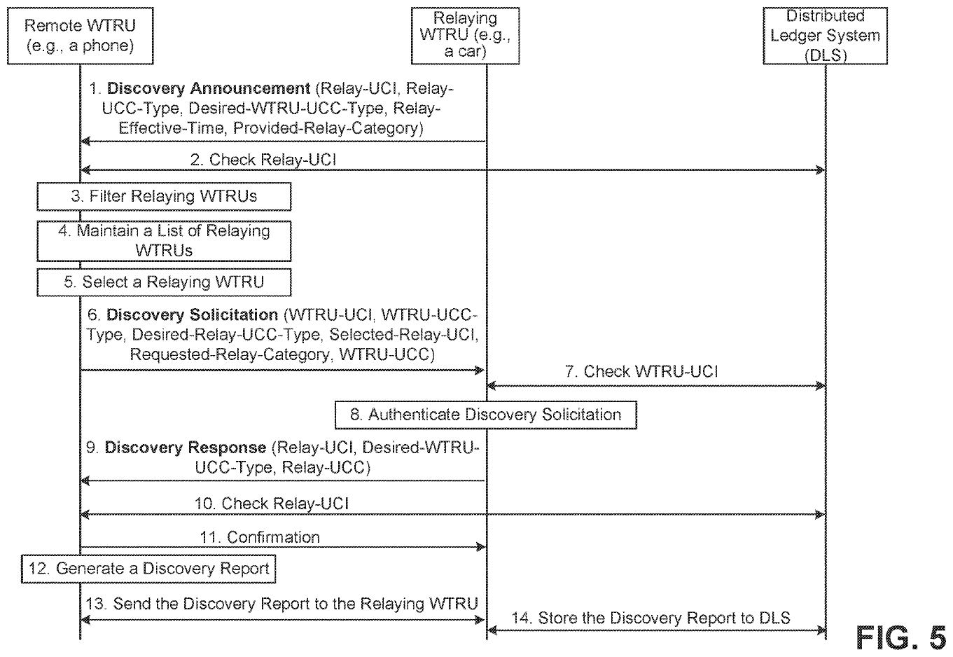

FIG. 5 illustrates a user-centric device discovery technique, which may provide trustworthy direct device discovery between remote WTRUs and relaying WTRUs. For example, the method may be used for a (e.g., one) remote WTRU to discover relaying WTRUs (e.g., multiple relay WTRUs) and/or for a (e.g., one) relaying WTRU to be discovered by (e.g., multiple) remote WTRUs. The UCI (e.g., and UCC) of remote WTRUs and relaying WTRUs may be embedded in the device discovery method, which may make the device discovery (e.g., more) trustworthy. A remote WTRU and a relaying WTRU may discover one another. The remote WTRU and/or the relaying WTRU may generate a device discovery report and store the device discovery report in a distributed ledger system (DLS).

At 1, a relay WTRU may broadcast a discovery announcement, which nearby remote WTRUs may receive (e.g., via a direct radio link). The discovery announcement may indicate the existence of the relaying WTRU and relaying WTRU's availability to provide relaying service. The discovery announcement may include the following example parameters. The discovery announcement may include one or more of a relay WTRU UCI, a relay WTRU UCC type, or a relay-effective time. The relay effective time may indicate a duration that a relay WTRU provides a relaying service.

Relay-UCI may be a unique UCI of the relaying WTRU. The relaying WTRU's Relay-UCI may be a blockchain address, an account address or identifier associated with the distributed ledger system, a derived number/string from the relaying WTRU's public key, and/or other public information (e.g., unique public information).

Relay-UCC-Type may be categories of UCCs that the relaying WTRU holds and may provide (e.g., on-demand) to be authenticated and authorized. Different Relay-UCC-Types may be used and supported by the technique. For example, Relay-UCC-Type may be related to the relaying WTRU's reputation that may be calculated based on one or more of the relaying service being provided in the past, the number of remotes WTRUs that the relaying WTRU has provided relaying service to, the subscription information of the relaying WTRU with one or more mobile operators, the feedback that other remote WTRUs have provided to the relaying WTRU, the credit score of the user of the relaying WTRU, the computing/storage/communication capabilities of the relaying WTRU, or the average energy efficiency or carbon efficiency of the relaying WTRU, etc.

Requested-WTRU-UCC-Type or a Desired-WTRU-UCC-Type may be the categories of the remote WTRU's UCCs that the relaying WTRU desires the remote WTRU to present to the relaying WTRU. A Desired-WTRU-UCC-Type may be used and supported by the method. For example, Desired-WTRU-UCC-Type may be related to the remote WTRU's reputation. The reputation may be calculated based on one or more of the relaying service being used in the past, the number of relaying WTRUs that the remote WTRU has been authorized by to use their relaying services, the subscription information of the remote WTRU with one or more mobile operators, the feedback that other relaying WTRUs have provided about the remote WTRU, or the credit score of the user of the remote WTRU, etc.

Relay-Effective-Time may indicate the time duration (e.g., from now on) that the relaying WTRU may stay online and provide relaying service.

Relay-Constraints (e.g., Relay-Parameters) may indicate relaying constraints (e.g., parameters) of the relaying WTRU (e.g., the data rate from the remote WTRU to the relaying WTRU, the data rate from the relaying WTRU to the remote WTRU, the buffer size for the traffic from the remote WTRU, the buffer size for the traffic to the remote WTRU, and the queuing time for the traffic from the remote WTRU, the queuing time for the traffic to the remote WTRU).

Connectivity-to-NW may indicate information about the relaying WTRU's connectivity to base stations (e.g., the identifier or the UCI of one or more base stations that the relaying WTRU may have connectivity with, the average upstream bandwidth to the base stations, the average downstream bandwidth from the base stations, etc.).

Provided-Relay-Category may indicate categories of relaying services that the relaying WTRU supports (e.g., WTRU-to-NW upstream relaying, WTRU-to-NW downstream relaying, WTRU-to-WTRU upstream relaying, and/or WTRU-to-WTRU downstream relaying, etc.)

At 2, the remote WTRU may receive the discovery announcement from the relaying WTRU. The remote WTRU may send a request with Relay-UCI to the DLS. The DLS may receive Relay-UCI from the remote WTRU and check the remote WTRUs existence and validity in the DLS based on the Relay-UCI. The DLS may respond to the remote WTRU indicating whether Relay-UCI is valid. The DLS (e.g., a distributed ledger node) may be co-located with the remote WTRU.

At 3, the remote WTRU may filter out a relaying WTRU based on the parameters included in the received discovery announcements from one or more relaying WTRUs. For example, if a remote WTRU does not have or does not support Desired-WTRU-UCC-Type, the remote WTRU may discard the corresponding relaying WTRU.

At 4, the remote WTRU may maintain a list of relaying WTRUs' candidates (e.g., keep their (e.g., the relaying WTRU(s)′) Relay-UCI and other parameters as received at 1).

At 5, based on the parameters received from the discovery announcement, the remote WTRU may select a relaying WTRU (e.g., an appropriate relaying WTRU). For example, the remote WTRU may choose a relaying WTRU with loose Relay-Constraints and/or (e.g., good) Connectivity-to-NW.

In examples, 1-5 may be optional. For example, if the remote WTRU does not receive a discovery announcement, the remote WTRU may not execute 2-5, and the remote WTRU may start at 6. If 1-5 have been performed, the remote WTRU may use 6 to rediscover the relaying WTRU or other relaying WTRUs. If the remote WTRU has discovered the relaying WTRU via 1-5, 6-10 may be skipped.

At 6, the remote WTRU may send a discovery solicitation to the selected relaying WTRU or broadcast the discovery solicitation to nearby WTRUs (e.g., through the direct radio). The discovery solicitation may include one or more parameters.

The parameters may include a WTRU-CUI. The WTRU-UCI may be the UCI (e.g., the unique UCI) of the remote WTRU (e.g., remote WTRU-UCI). The remote WTRU's WTRU-UCI may be a blockchain address, an account address or identifier associated with the DLS, and/or a derived number/string from the remote WTRU's public key and/or other public information (e.g., unique public information).

The parameters may include a Selected-Relay-UCI. The Selected-Relay-UCI may be the UCI of the relaying WTRU. The parameter may be optional when the remote WTRU has not received a discovery announcement.

The parameters may include a WTRU-UCC-Type. WTRU-UCC-Type (e.g., remote WTRU-UCC-Type) may be the categories of the remote WTRU's UCCs. WTRU-UCC-Types (e.g., Different WTRU-UCC-Types) may be used and supported by the technique. For example, a WTRU-UCC-Type may be related to the remote WTRU's reputation. The remote WTRU's reputation may be calculated based on one or more of the relaying service being used in the past, the number of relaying WTRUs for which the remote WTRU has been authorized to use relaying services, the subscription information of the remote WTRU with one or more mobile operators, the feedback that (e.g., other) relaying WTRUs have provided about the remote WTRU, or the credit score of the user of the remote WTRU, etc. If the remote WTRU has received the discovery announcement at 1, WTRU-UCC-Type may be a subset of Desired-WTRU-UCC-Type.

The parameters may include a Desired-Relay-UCC-Type. The Desired-Relay-UCC-Type may be the categories of the relaying WTRU's UCCs that the remote WTRU desires the relaying WTRU to present to the remote WTRU. If the remote WTRU has received the discovery announcement at 1, Desired-Relay-UCC-Type may be a subset of Relay-UCC-Type.

The parameters may include a Requested-Relay-Category. The Requested-Relay-Category may indicate the categories of relaying services that the remote WTRU requests (e.g., WTRU-to-NW upstream relaying, WTRU-to-NW downstream relaying, WTRU-to-WTRU upstream relaying, and/or WTRU-to-WTRU downstream relaying, etc.).

The parameters may include a WTRU-UCC. The WTRU-UCC (e.g., remote WTRU-UCC) may be the UCC of the remote WTRU belonging to the WTRU-UCC-Type. The parameter may be optional at 6. WTRU-UCC may include one or more of the following parameters: WTRU-UCI; a UCI or other identifier of the issuer entity that has issued the WTRU-UCC; one or more statements about the remote WTRU; the issuer entity's signature on the statements; and/or the public key of the issuer entity.

At 7, the relaying WTRU may receive the discovery solicitation from the remote WTRU. The relaying WTRU may send a request with WTRU-UCI to the DLS. For example, the DLS may receive WTRU-UCI from the relaying WTRU and may check its existence and validity in the DLS. The DLS may respond to the relaying WTRU indicating whether WTRU-UCI is valid. The DLS (e.g., a distributed ledger node) may be co-located with the relaying WTRU.

If WTRU-UCC is included at 6, the relaying WTRU may extract the UCI or the identifier of the issuer entity. The relaying WTRU may request the DLS to retrieve other public information about the issuer entity (e.g., the issuer entity's public key). The DLS may respond to the relaying WTRU with the requested information about the issuer entity. The relaying WTRU may use the information and other information included in WTRU-UCC (e.g., a statement signature) to verify, for example, one or more of the following: that the content of WTRU-UCC has not been changed by another entity since it was issued by the issuer entity and/or that the WTRU-UCC has been issued by the issuer entity. If both are satisfied, WTRU-UCC may be valid.

If WTRU-UCI or WTRU-UCC is not valid at 7, the method may be stopped, and one or more actions may not be performed.

At 8, if the WTRU-UCI (e.g., the remote WTRU-UCI) (and WTRU-UCC (e.g., the remote WTRU-UCC) is valid at 7 (e.g., the relay WTRU may verify the remote WTRU UCI and the remote WTRU UCC based on the discovery solicitation), the relaying WTRU may continue to authenticate and authorize the discovery solicitation. For example, if the remote WTRU does not support Desired-WTRU-UCC-Type, the relaying WTRU may not send a discovery response to the remote WTRU. In an example, if the relaying WTRU does not support Desired-Relay-UCC-Type, the relaying WTRU may not send a discovery response to the remote WTRU. If the relaying WTRU does not support Requested-Relay-Category, the relaying WTRU may not send a discovery response.

At 9, the relaying WTRU may send a discovery response to the remote WTRU indicating that WTRU-UCI and WTRU-UCC are valid. The discovery response may include the following parameters.

Relay-UCI may be the (e.g., unique) UCI of the relaying WTRU that sends the discovery response. The relaying WTRU's Relay-UCI may be a blockchain address, an account address or identifier associated with DLS, a derived number/string from the relaying WTRU's public key, and/or other public information (e.g., unique public information).

Desired-WTRU-UCC-Type may be similar to 1 and may be optional at 9 when the parameter has been at 1.

Relay-UCC may be the UCC of the relaying WTRU, which may match the type designated by Desired-Relay-UCC-Type as included at 6. The parameter may be optional at 9.

At 10, similar to 7, the remote WTRU may verify Relay-UCI and Relay-UCC leveraging the DLS.

At 11, if Relay-UCI and Relay-UCC are valid at 10, the remote WTRU may send a confirmation (e.g., a confirmation indication) to the relaying WTRU indicating that: 1) Relay-UCI and Relay-UCC are valid, and 2) the remote WTRU may start to request a relaying service from the relaying WTRU. The confirmation indication may include an indication indicating that the relay WTRU UCI and the relay WTRU UCC are valid or a second indication indicating that the remote WTRU may request a relaying service from the relay WTRU.

At 12, the remote WTRU may generate a discovery report, which may include that: WTRU-UCI (e.g., remote WTRU-UCI) as the remote WTRU, relay WTRU-UCI as the relaying WTRU, the current time, the discovery approach (e.g., announcement or solicitation), whether the relaying WTRU has verified the WTRU-UCC (e.g., the remote WTRU-UCC), whether the remote WTRU has verified Relay-UCC, and/or the signature of the remote WTRU. The discovery report may include one or more of the remote WTRU UCI, the relay WTRU UCI, a timestamp indicating when the discovery report was generated, a verification status of the remote WTRU UCC, or a verification status of the relay WTRU UCC.

At 13, the remote WTRU may send (e.g., transmit) the discovery report to the relaying WTRU.

At 14, the relaying WTRU may verify the content of the (e.g., received) discovery report, including the remote WTRU's signature (e.g., the discovery report may be verified based on the signature of the remote WTRU). The relaying WTRU may add its signature to the discovery report and store the discovery report in the DLS. The DLS may respond to the relaying WTRU indicating where the discovery report has been stored in the DLS. In an example, the relaying WTRU may forward the response to the remote WTRU.

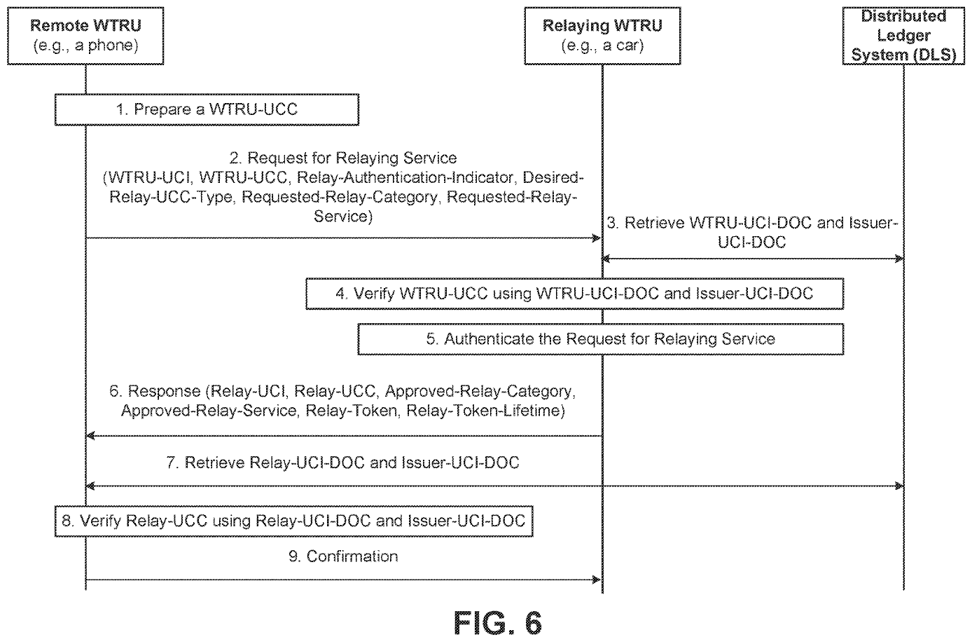

FIG. 6 illustrates a user-centric relaying service request technique (e.g., a UCC-Aware Relaying Service Request. After a remote WTRU discovers a relaying WTRU, the remote WTRU may use the method to request relaying service from the relaying WTRU by presenting its UCC (e.g., WTRU-UCC) to the relaying WTRU. The relaying WTRU may (e.g., may need to) authenticate and authorize the relaying service request by verifying WTRU-UCC from the remote WTRU based on public information stored in the DLS. The remote WTRU may also authenticate the relaying WTRU by verifying its UCC (e.g., Relay-UCC) using the DLS. Leveraging the DLS, the relaying WTRU, and the remote WTRU may authenticate one other (e.g., without relying on a centralized entity). By verifying WTRU-UCC and Relay-UCC, the remote WTRU and the relaying WTRU may (e.g., automatically) build trust relationships as part of the relaying service request technique.

At 1, the remote WTRU may prepare a WTRU-UCC. If the remote WTRU has received UCCs from an issuer entity, the remote may select and combine (e.g., some) UCCs to generate a WTRU-UCC that matches Desired-WTRU-UCC-Type by the relaying WTRU. The remote WTRU may have known Desired-WTRU-UCC-Type from the user-centric device discovery technique. If the remote WTRU does not have UCCs matching Desired-WTRU-UCC-Type, the remote WTRU may request a (e.g., new) UCC from an issuer entity, and the issuer entity may issue a (e.g., new) UCC matching Desired-WTRU-UCC-Type.

At 2, the remote WTRU may request the relaying WTRU to request relaying service. The request may include the following parameters.

WTRU-UCI may be the UCI (e.g., the unique UCI) of the remote WTRU. The remote WTRU's WTRU-UCI may be a blockchain address, an account address or identifier associated with DLS, a derived number/string from the remote WTRU's public key, public information (e.g., unique public information), and/or the like.

WTRU-UCC may be the UCC of the remote WTRU. WTRU-UCC may include one or more of the following parameters: WTRU-UCI, a UCI or other identifier of the issuer entity that has issued the WTRU-UCC, one or more statements about the remote WTRU, the issuer entity's signature on the statements, the public key of the issuer entity, and/or the like.

Requested-Relay-Category may indicate the categories of relaying services that the remote WTRU requests (e.g., one or more of WTRU-to-NW upstream relaying, WTRU-to-NW downstream relaying, WTRU-to-WTRU upstream relaying, or WTRU-to-WTRU downstream relaying, etc.).

Requested-Relay-Service may indicate requested relaying service specifications (e.g., one or more of the requested time duration for using the relaying service, requested data rate from the remote WTRU to the relaying WTRU, the requested data rate from the relaying WTRU to the remote WTRU, the requested buffer size for the traffic from the remote WTRU, the requested buffer size for the traffic to the remote WTRU, the requested maximum queuing time for the traffic from the remote WTRU, or the requested maximum queuing time for the traffic to the remote WTRU, etc.).

Relay-Authentication-Indicator may indicate whether the remote WTRU demands to authenticate the relaying WTRU. If the remote WTRU indicates to authenticate the relaying WTRU, the remote WTRU may expect to receive Relay-UCC of the relaying WTRU at 6.

Desired-Relay-UCC-Type may be the categories of the relaying WTRU's UCCs that the remote WTRU desires the relaying WTRU to present to the remote WTRU. The parameter may not be needed if Relay-Authentication-Indicator indicates that the remote WTRU does not want to authenticate the relaying WTRU.

At 3, the relaying WTRU may use WTRU-UCI to retrieve the corresponding WTRU-UCI-DOC from the DLS. In examples, the WTRU-UCI-DOC may be a document including public information about the remote WTRU (e.g., a public key of the remote WTRU). The WTRU-UCI-DOC may have been stored onto the DLS as a part of a UCI generation technique for the remote WTRU. The relaying WTRU may extract Issuer-UCI (e.g., the UCI of the issuer entity that has issued WTRU-UCC) from WTRU-UCC. The relaying WTRU may use Issuer-UCI to retrieve the Issuer-UCI-DOC from the DLS. The Issuer-UCI-DOC may be a document that includes public information about the issuer entity (e.g., its public key). The Issuer-UCI-DOC may have been stored onto the DLS as a part of a UCI generation technique for the issuer entity.

At 4, the relaying WTRU may use information from WTRU-UCI-DOC and Issuer-UCI-DOC to verify WTRU-UCC, for example, to verify that: 1) the content of WTRU-UCC has not been changed by another entity since the issuer entity issued it, and 2) the issuer entity has issued the WTRU-UCC. If 1) and 2) are satisfied, WTRU-UCC may be valid. For 1), the relaying WTRU may use the issuer entity's signature included in WTRU-UCC to verify that the content of WTRU-UCC has not been modified. For 2), the relaying WTRU may use the issuer entity's public key to verify that the issuer entity has issued the signature in WTRU-UCC. If WTRU-UCC includes the remote WTRU's signature, the relaying WTRU may use the remote WTRU's public key to verify that the signature is from the remote WTRU.

At 5, if WTRU-UCC is valid as a result of 4, the relaying WTRU may trust the remote WTRU. The relaying WTRU may continue to authenticate the relaying service request (e.g., at 2), for example, to check if Requested-Relay-Category and Requested-Relay-Service are allowed based on provisioned relaying service policies (e.g., allowed maximum K=5 remote WTRUs concurrently using the relaying WTRU, the remote WTRU may not be allowed to use the relaying WTRU for not more than N=30 minutes within M=1 day). For example, the relaying WTRU may continue to authenticate the relaying service request (e.g., at 2) to check if the relaying WTRU has sufficient resources (e.g., computing, communication, storage) to provide Requested-Relay-Category and Requested-Relay-Service. According to the provisioned relaying service policies and/or the relaying WTRU's resources, the relaying WTRU may approve a subset of Requested-Relay-Category and Requested-Relay-Service, referred to as Approved-Relay-Category and Approved-Relay-Service. If the remote WTRU includes Relay-Authentication-Indicator and Desired-Relay-UCC-Type, the relaying WTRU may check whether its current UCC (e.g., Relay-UCC) matches Desired-Relay-UCC-Type. If not, the relaying WTRU may skip the following or request a new Relay-UCC from an issuer entity.

At 6, if the verification and authentication at 4 and 5 passes, the relaying WTRU may generate a response and send the response to the remote WTRU. The response may include one or more of the following parameters:

Relay-UCI may be the UCI of the relaying WTRU. The parameter may be used if the remote WTRU is requested to authenticate the relaying WTRU at 2.

Relay-UCC may be the UCC of the relaying WTRU. The parameter may be used if the remote WTRU is requested to authenticate the relaying WTRU at 2.

Approved-Relay-Category may indicate that relaying categories are approved by the relaying WTRU at 5.

Approved-Relay-Service may indicate that the relaying WTRU approves the relaying services at 5 (e.g., the approved relay service may be 5 minutes for the remote WTRU).

Relay-Token may be a (e.g., random) number that the remote WTRU uses for future (e.g., direct) communications with the relaying WTRU. Relay-Token may be valid for a time period as indicated by Relay-Token-Lifetime. Relay-Token may be generated and/or derived based on parameters (e.g., WTRU-UCI, Relay-UCI, etc.), and it may be (e.g., uniquely) for the combination of the remote WTRU and the relaying WTRU. If Relay-Token is included at 6, the remote WTRU may include it in its (e.g., future) communications with the relaying WTRU and/or use Relay-Token to generate tokens and include these tokens in future communications with the relaying WTRU.

Relay-Token-Lifetime may indicate the lifetime or the valid time for Relay-Token.

At 7, if Relay-UCI and Relay-UCC have been included at 6, the remote WTRU may use Relay-UCI to retrieve a corresponding Relay-UCI-DOC from the DLS. Relay-UCI-DOC may be a document that includes public information about the relaying WTRU (e.g., its public key). Relay-UCI-DOC may have been stored onto the DLS as a part of a UCI generation technique for the relaying WTRU. The remote WTRU may extract Issuer-UCI (e.g., the UCI of the issuer entity that has issued Relay-UCC) from Relay-UCC. The remote WTRU may use Issuer-UCI to retrieve Issuer-UCI-DOC from the DLS. Issuer-UCI-DOC may be a document that includes public information about the issuer entity (e.g., its public key). Issuer-UCI-DOC may be stored onto the DLS as a part of a UCI generation technique for the issuer entity.

At 8, if Relay-UCI and Relay-UCC have been included at 6, the remote WTRU may use information from Relay-UCI-DOC and Issuer-UCI-DOC to verify Relay-UCC. For example, the remote WTRU may use information from Relay-UCI-DOC and Issuer-UCI-DOC to verify that: 1) the content of Relay-UCC has not been changed by another entity since the issuer entity issued it, and 2) the issuer entity has issued WTRU-UCC. If 1) and 2) are satisfied, Relay-UCC may be valid. For 1), the remote WTRU may use the issuer entity's signature included in Relay-UCC to verify that the content of Relay-UCC has not been modified. For 2), the remote WTRU may use the issuer entity's public key to verify that the issuer entity has issued the signature included in Relay-UCC. If Relay-UCC includes the relaying WTRU's signature, the remote WTRU may use the relaying WTRU's public key to verify that the signature is from the relay WTRU.

At 9, the remote WTRU may send a confirmation to the relaying WTRU indicating whether the relaying WTRU has been authenticated and whether Relay-UCC is valid as a result of 8.

Systems, methods, and instrumentalities are disclosed for user-centric relaying services. In examples, a relay wireless transmit/receive unit (WTRU) may receive, from a remote WTRU, a discovery solicitation. The discovery solicitation may include at least one of a remote WTRU User-Centric Identifier (UCI), a remote WTRU User-Centric Credential (UCC) type, or a relay WTRU UCC type. The relay WTRU may verify the remote WTRU UCI based on the discovery solicitation. The relay WTRU may authenticate the discovery solicitation using the verified remote WTRU UCI. The relay WTRU may send a discovery response to the remote WTRU if the discovery solicitation is authenticated. The discovery response may include at least one of a relay WTRU UCI, a preferred remote WTRU UCC type, or a relay WTRU UCC. The relay WTRU may receive a discovery report from the remote WTRU. The discovery report may be based on a confirmation received from the remote WTRU. The relay WTRU may send the discovery report to a network node.

The network node may include a distributed ledger system (DLS). The relay WTRU may send a discovery announcement to the remote WTRU. The discovery announcement may include at least one of the relay WTRU UCI, the relay WTRU UCC type, or a relay-effective time. The relay-effective time may indicate a duration of time that the relay WTRU provides a relaying service. The relay WTRU may verify the remote WTRU UCC type based on the discovery solicitation.

The confirmation may include at least one of a first confirmation indication indicating that the relay WTRU UCI and the relay WTRU UCC type are valid, or a second indication indicating that the remote WTRU may request relaying service from the relay WTRU. The discovery report may include at least one of the remote WTRU UCI, the relay WTRU UCI, a timestamp indicating when the discovery report was generated, a verification status of the remote WTRU UCC type, or a verification status of the relay WTRU UCC type. The relay WTRU may verify the discovery report. The discovery report may be verified based on a signature of the remote WTRU.

Systems, methods, and instrumentalities are disclosed for user-centric relaying services. In examples, a relay wireless transmit/receive unit (WTRU) may receive, from a proximity service (ProSe) function, a first message. The first message may include a request to configure the relay WTRU with a type of user-centric identifier (UCI) and a type of user-centric credential (UCC). The relay WTRU may send a second message to the ProSe function in response to the first message. The second message may include the type of UCI corresponding with the relay WTRU and the type of UCC corresponding with the relay WTRU. The relay WTRU may generate a UCI in accordance with the first message. The relay WTRU may send, to a user-centric credential issuer (UCCI), a third message. The third message may include a request to generate a UCC based at least on the UCI and the type of UCC. The relay WTRU may receive, from the UCCI, a fourth message, and the fourth message may include a request to present an existing UCC of the relay WTRU to the UCCI. The relay WTRU may, based on the fourth message, send the existing UCC to the UCCI. The relay WTRU may receive the UCC from the UCCI. The relay WTRU may configure the relay WTRU with the UCI and the UCC.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-14. (canceled)

15. A relay wireless transmit/receive unit (WTRU) comprising:
a processor configured to:
receive, from a remote WTRU, a discovery solicitation, wherein the discovery solicitation comprises at least one of a remote WTRU User-Centric Identifier (UCI), a remote WTRU User-Centric Credential (UCC) type, or a relay WTRU UCC type;
verify the remote WTRU UCI based on the discovery solicitation;
authenticate the discovery solicitation using the verified remote WTRU UCI;
send a discovery response to the remote WTRU if the discovery solicitation is authenticated, wherein the discovery response comprises at least one of a relay WTRU UCI, a preferred remote WTRU UCC type, or a relay WTRU UCC;
receive a discovery report from the remote WTRU, wherein the discovery report is based on a confirmation received from the remote WTRU; and
send the discovery report to a network node.

16. The relay WTRU of claim 15, wherein the network node comprises a distributed ledger system (DLS).

17. The relay WTRU of claim 15, wherein the processor is further configured to:
send a discovery announcement to the remote WTRU, wherein the discovery announcement comprises at least one of the relay WTRU UCI, the relay WTRU UCC type, or a relay-effective time, and wherein the relay-effective time indicates a duration of time that the relay WTRU provides a relaying service.

18. The relay WTRU of claim 15, wherein the processor is further configured to verify the remote WTRU UCC type based on the discovery solicitation.

19. The relay WTRU of claim 15, wherein the confirmation comprises at least one of a first confirmation indication indicating that the relay WTRU UCI and the relay WTRU UCC type are valid, or a second confirmation indication indicating that the remote WTRU may request relaying service from the relay WTRU.

20. The relay WTRU of claim 15, wherein the discovery report further comprises at least one of the remote WTRU UCI, the relay WTRU UCI, a timestamp indicating when the discovery report was generated, a verification status of the remote WTRU UCC type, or a verification status of the relay WTRU UCC type.

21. The relay WTRU of claim 15, wherein the processor is further configured to:
verify the discovery report, wherein the discovery report is verified based on a signature of the remote WTRU.

22. A method for a relay wireless transmit/receive unit (WTRU) comprising:
receiving, from a remote WTRU, a discovery solicitation, wherein the discovery solicitation comprises at least one of a remote WTRU User-Centric Identifier (UCI), a remote WTRU User-Centric Credential (UCC) type, or a relay WTRU UCC type;
verifying the remote WTRU UCI based on the discovery solicitation;
authenticating the discovery solicitation using the verified remote WTRU UCI;
sending a discovery response to the remote WTRU if the discovery solicitation is authenticated, wherein the discovery response comprising at least one of a relay WTRU UCI, a preferred remote WTRU UCC type, or a relay WTRU UCC;
receiving a discovery report from the remote WTRU, wherein the discovery report is based on a confirmation received from the remote WTRU; and
sending the discovery report to a network node.

23. The method of claim 22, wherein the network node comprises a distributed ledger system (DLS).

24. The method of claim 22, wherein the method further comprises:
sending a discovery announcement to the remote WTRU, wherein the discovery announcement comprises at least one of the relay WTRU UCI, the relay WTRU UCC type, or a relay-effective time, and wherein the relay-effective time indicates a duration of time that the relay WTRU provides a relaying service.

25. The method of claim 22, wherein the method further comprises:
verifying the remote WTRU UCC type based on the discovery solicitation.

26. The method of claim 22, wherein the confirmation comprises at least one of a first confirmation indication indicating that the relay WTRU UCI and the relay WTRU UCC type are valid, or a second confirmation indication indicating that the remote WTRU may request relaying service from the relay WTRU.

27. The method of claim 22, wherein the discovery report further comprises at least one of the remote WTRU UCI, the relay WTRU UCI, a timestamp indicating when the discovery report was generated, a verification status of the remote WTRU UCC type, or a verification status of the relay WTRU UCC type.

28. The method of claim 22, wherein the method further comprises:
verifying the discovery report, wherein the discovery report is verified based on a signature of the remote WTRU.
